(19) United States
(12) Patent Application Publication
(10) Pub. No.: US 2024/0157922 A1
(43) Pub. Date: May 16, 2024

(54) BRAKE DEVICE

(71) Applicant: DENSO CORPORATION, Kariya-city (JP)

(72) Inventors: Kengo ITO, Kariya-city (JP); Etsugo YANAGIDA, Kariya-city (JP); Koichi FUKAYA, Kariya-city (JP); Hiroyuki KODAMA, Kariya-city (JP); Sho FUKAMI, Kariya-city (JP)

(21) Appl. No.: 18/420,375

(22) Filed: Jan. 23, 2024

Related U.S. Application Data
(63) Continuation of application No. PCT/JP2022/028608, filed on Jul. 25, 2022.

(30) Foreign Application Priority Data
Aug. 23, 2021 (JP) 2021-135853

(51) Int. Cl. B60T 13/14; B60T 7/04

(52) U.S. Cl. CPC B60T 13/147; B60T 7/04

(57) ABSTRACT

A brake device includes a brake pedal, a pedal operation detection section, a tank section, an actuator, a master cylinder, a brake fluid path and a reaction force generating section. The master cylinder includes a cylinder section that forms a storage chamber for storing brake fluid and a piston rod that connects to the brake pedal and pushes out the brake fluid stored in the storage chamber and discharges the brake fluid to an outside of the cylinder section by moving a distance corresponding to an amount of operation of the brake pedal. The brake fluid flow path guides the brake fluid discharged from the storage chamber by being pushed out by the piston rod to the tank section. The reaction force generating section includes an elastic member that generates a reaction force on the brake pedal by elastically deforming according to the amount of operation of the brake pedal.

### CROSS REFERENCE TO RELATED APPLICATIONS

This application is a continuation application of International Patent Application No. PCT/JP2022/028608 filed on Jul. 25, 2022, which designated the U.S. and based on and claims the benefits of priority of Japanese Patent Application No. 2021-135853 filed on Aug. 23, 2021. The entire disclosure of all of the above applications is incorporated herein by reference.

### TECHNICAL FIELD

The present disclosure relates to a brake device.

### BACKGROUND

Conventionally, a brake device is known that includes a brake pedal, a master cylinder, a stroke simulator corresponding to a reaction force generating section, a simulator cut valve, a master cut valve, and a brake actuator.

### SUMMARY

An object of the present disclosure is to provide a brake device that can improve an operational feeling of the brake pedal.

According to one aspect of the present disclosure,
a brake device that brakes wheels of a vehicle includes
a brake pedal,
a pedal operation detection section that detects an amount of operation of the brake pedal,
a tank section that stores brake fluid,
an actuator that pressurizes the brake fluid stored in the tank to a brake fluid pressure corresponding to the amount of operation of the brake pedal,
a master cylinder including a cylinder section forming a storage chamber for storing brake fluid and a piston rod that connects to the brake pedal and pushes out the brake fluid stored in the storage chamber and discharges the brake fluid to an outside of the cylinder section by moving a distance corresponding to the amount of operation of the brake pedal,
a brake fluid flow path that guides brake fluid discharged from the storage chamber by being pushed out by the piston rod to the tank section, and
a reaction force generating section that is connected to the brake pedal and includes an elastic member that generates a reaction force on the brake pedal by elastically deforming according to the amount of operation of the brake pedal.

### BRIEF DESCRIPTION OF DRAWINGS

FIG. 1 is a schematic configuration diagram of a brake device according to a present embodiment; and

FIG. 2 is a sectional view of a periphery of a reaction force generating section according to the present embodiment.

### DETAILED DESCRIPTION

In an assumable example, a brake device is known that includes a brake pedal, a master cylinder, a stroke simulator corresponding to a reaction force generating section, a simulator cut valve, a master cut valve, and a brake actuator. In the brake device, during normal use, the master cut valve is in a closed state and the simulator cut valve is in an open state. Brake fluid, which is working fluid pressurized from the master cylinder by depression of the brake pedal, flows into the stroke simulator. On the other hand, the stroke simulator generates a reaction force on the brake pedal via the master cylinder according to hydraulic pressure of the brake fluid flowing from the master cylinder.

As described above, in the brake device described above, during normal use, the stroke simulator is operated by the brake fluid sent from the master cylinder. That is, since brake fluid is present between the brake pedal and the reaction force generating section, there is room for improvement in an operational feeling of the brake pedal. The inventors have found through intensive studies that there is room for improvement in the operational feeling.

An object of the present disclosure is to provide a brake device that can improve the operational feeling of the brake pedal.

According to one aspect of the present disclosure,
a brake device that brakes wheels of a vehicle includes
a brake pedal,
a pedal operation detection section that detects an amount of operation of the brake pedal,
a tank section that stores brake fluid,
an actuator that pressurizes the brake fluid stored in the tank to a brake fluid pressure corresponding to the amount of operation of the brake pedal,
a master cylinder including a cylinder section forming a storage chamber for storing brake fluid and a piston rod that connects to the brake pedal and pushes out the brake fluid stored in the storage chamber and discharges the brake fluid to an outside of the cylinder section by moving a distance corresponding to the amount of operation of the brake pedal,
a brake fluid flow path that guides brake fluid discharged from the storage chamber by being pushed out by the piston rod to the tank section, and
a reaction force generating section that is connected to the brake pedal and includes an elastic member that generates a reaction force on the brake pedal by elastically deforming according to the amount of operation of the brake pedal.

In this way, the reaction force generating section is configured to generate a reaction force on the brake pedal by elastically deforming the elastic member according to the amount of operation of the brake pedal, without using the hydraulic pressure of the brake fluid discharged from the master cylinder. According to this configuration, no brake fluid is present between the brake pedal and the reaction force generating section. Therefore, since the reaction force can be directly transmitted to the brake pedal, the operational feeling of the brake pedal can be improved.

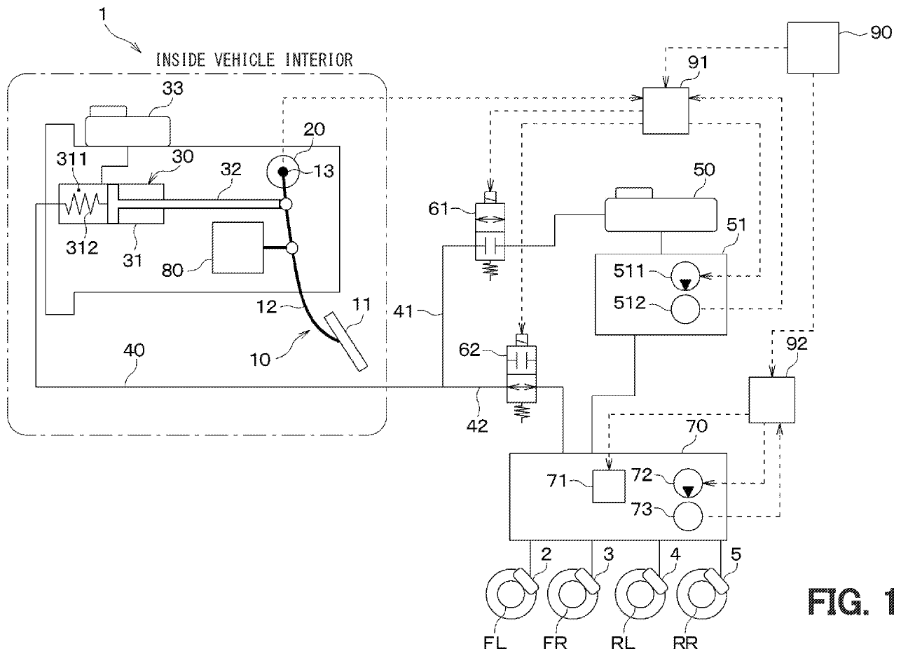

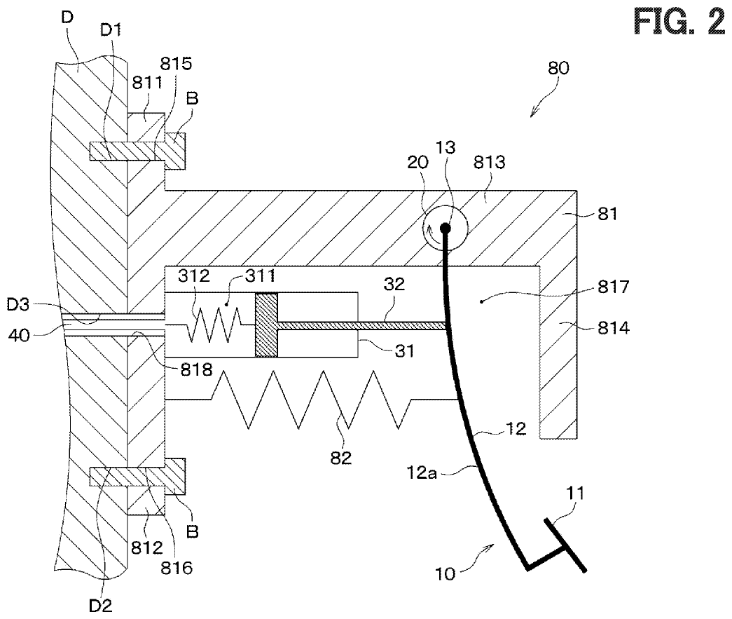

An embodiment of the present disclosure will be described based on FIGS. 1 and 2. As shown in FIG. 1, a brake device 1 of the present embodiment is used to brake a left front wheel FL, a right front wheel FR, a left rear wheel RL, and a right rear wheel RR, which are each wheel of a vehicle.

As shown in FIG. 1, the brake device 1 includes a wheel cylinder 2 for the left front wheel, a wheel cylinder 3 for the right front wheel, a wheel cylinder 4 for the left rear wheel, and a wheel cylinder 5 for the right rear wheel. These wheel cylinders 2, 3, 4, and 5 apply braking force to each of the front left wheel FL, front right wheel FR, rear left wheel RL, and rear right wheel RR by being operated by the hydraulic pressure of brake fluid. Hereinafter, each of the wheel cylinders is referred to as a W/C for convenience.

The brake device 1 also includes a brake pedal 10, a stroke sensor 20, a master cylinder 30, a brake fluid flow path 40, a tank section 50, a first actuator 51, a master bypass valve 61, and a cut valve 62, and a second actuator 70. The brake device 1 includes a reaction force generating section 80, a power supply 90, a first ECU 91, and a second ECU 92. ECU is an abbreviation for Electronic Control Unit.

The W/C2 for the left front wheel is arranged corresponding to the left front wheel FL. The W/C3 for the right front wheel is arranged corresponding to the right front wheel FL. The W/C4 for the left rear wheel is arranged corresponding to the left rear wheel RL. The W/C5 for the right rear wheel is arranged corresponding to the right rear wheel RR. Further, the W/C2 for the left front wheel, the W/C3 for the right front wheel, the W/C4 for the left rear wheel, and the W/C5 for the right rear wheel are connected to respective brake pads (not shown) of the vehicle.

The brake pedal 10 is an operating member operated by being stepped on by a driver of the vehicle, and is provided inside a vehicle interior. The brake pedal 10 has a pedal section 11, a lever section 12, and a rotating shaft 13. The pedal section 11 is a section that is stepped on by the driver of the vehicle. The lever section 12 is a rod-shaped member, and one end side is connected to the pedal section 11, and the other end side is connected to the rotating shaft 13. The lever section 12 is configured to be rotatable about the rotating shaft 13 when the pedal section 11 is stepped on by the driver of the vehicle. Further, the rotating shaft 13 is provided with a stroke sensor 20.

The stroke sensor 20 is a sensor that detects pedal operation information regarding the amount of operation of the brake pedal 10 when the brake pedal 10 is operated by the driver. Specifically, the stroke sensor 20 is a rotation angle sensor that detects a rotation angle of the lever section 12 that rotates when the driver depresses the pedal section 11. The stroke sensor 20 outputs a detection signal corresponding to the rotation angle of the lever section 12 about the rotating shaft 13 to the first ECU 91, which will be described later.

The stroke sensor 20 may output a detection signal to the first ECU 91 according to the stroke amount of the brake pedal 10, which changes depending on the driver's depression operation of the pedal section 11. In the present embodiment, the stroke sensor 20 functions as a pedal operation detection section.

The master cylinder 30 has a cylinder section 31, a piston rod 32, and a master reservoir 33. The master cylinder 30 is provided inside the vehicle interior, and is housed, for example, inside a dashboard (not shown) provided inside the vehicle interior.

The cylinder section 31 has a cylindrical shape with a bottom, and stores brake fluid, which is a working fluid, in a storage chamber 311 formed inside of the cylinder section 31. The piston rod 32 is inserted into the cylinder section 31 from the opening side. Further, a spring 312 is housed in the storage chamber 311 in the cylinder section 31. The storage chamber 311 is connected to the master reservoir 33 and the brake fluid flow path 40.

The piston rod 32 closes an opening side of the cylinder section 31 and pushes out the brake fluid stored in the storage chamber 311 of the cylinder section 31. The piston rod 32 is connected to the lever section 12 of the brake pedal 10. The piston rod 32 moves in an axial direction of the cylinder section 31 by a distance corresponding to the amount of operation of the brake pedal 10 and is pushed into the cylinder section 31, when the lever section 12 rotates around the rotating shaft 13 due to the driver's depression of the pedal section 11. The piston rod 32 is pushed into the cylinder section 31 so as to push the brake fluid stored in the storage chamber 311 to the outside of the cylinder section 31.

The brake fluid pushed out from the cylinder section 31 is discharged into the brake fluid flow path 40 and flows into the tank section 50. Furthermore, when the driver no longer depresses the pedal section 11, the piston rod 32 is moved to its original position by the urging force of the spring 312 housed in the storage chamber 311.

The cylinder section 31 and the piston rod 32 are housed in the reaction force generating section 80, which will be described later, as shown in FIG. 2. In FIG. 2, the master reservoir 33 is not shown.

In this way, in the master cylinder 30 of the present embodiment, the piston rod 32 is mechanically directly connected to the brake pedal 10, and it is configured such that the depression force generated on the pedal section 11 when the driver steps on the brake pedal 10 is directly transmitted to the master cylinder 30. The master cylinder 30 is configured such that brake fluid does not flow between the brake pedal 10 and the piston rod 32.

The master reservoir 33 is a tank that stores brake fluid. The master reservoir 33 is configured to supply the brake fluid to be stored when the brake fluid in the cylinder section 31 is insufficient, and also to be supplied with brake fluid from the cylinder section 31 and to be able to store the brake fluid when the brake fluid in the cylinder section 31 is surplus.

The brake fluid flow path 40 is a flow path that guides the brake fluid discharged from the cylinder section 31 to the W/C2 for the left front wheel, the W/C3 for the right front wheel, the W/C4 for the left rear wheel, and the W/C5 for the right rear wheel through the second actuator 70. One side of the brake fluid flow path 40 communicates with the cylinder section 31. Further, the other side of the brake fluid flow path 40 is branched in a middle, and one of the branched flow paths is communicated with the second actuator 70 via the tank section 50 and the first actuator 51. The other of the branched flow paths is communicated with the second actuator 70 without flowing through the tank section 50 and the first actuator 51.

Hereinafter, one of the branched flow paths is referred to as a first flow path 41, and the other of the flow paths is referred to as a second flow path 42. The first flow path 41 is a flow path that guides the brake fluid discharged from the cylinder section 31 to each of the W/C2, the W/C3, the W/C4, and the W/C5 via the tank section 50, the first actuator 51, and the second actuator 70. The second flow path 42 is a flow path that guides the brake fluid discharged from the cylinder section 31 to each of the W/C2, the W/C3, the W/C4, and the W/C5 via the second actuator 70 without flowing through the tank section 50 and the first actuator 51.

The first flow path 41 is provided with the master bypass valve 61 that opens and closes the first flow path 41. The second flow path 42 is provided with the cut valve 62 that opens and closes the second flow path 42. In the present embodiment, the master bypass valve 61 functions as a first control valve, and the cut valve 62 functions as a second control valve.

Although not shown, the brake device 1 of the present embodiment includes two piping systems that guide the brake fluid discharged from the cylinder section 31 to the second actuator 70. That is, the brake device 1 includes another piping system (not shown) having the brake fluid flow path 40, the master bypass valve 61, and the cut valve 62. Further, although not shown, in the master cylinder 30 of the present embodiment, the storage chamber 311 is divided into two spaces, and each of the two spaces functions as a storage section that stores brake fluid. A flow path that guides the brake fluid discharged from the cylinder section 31 to the second actuator 70 is independently connected to each of the two storage sections.

Further, a flow path connected to one of the two storage sections is connected to the W/C2 for the left front wheel and the W/C3 for the right front wheel via the second actuator 70. Further, a flow path connected to the other of the two storage sections is connected to the W/C 4 for the left rear wheel and the W/C 5 for the right rear wheel via the second actuator 70. With this configuration, even if brake fluid cannot flow through one flow path, the brake device 1 is configured to be possible of braking the vehicle by flowing brake fluid through the other flow path.

The master bypass valve 61 is a two-position solenoid valve of normally closed type that can control a communicating state and a blocking state. Specifically, when the solenoid coil is in a non-energized state, the master bypass valve 61 is in the blocking state, thereby closing the first flow path 41 and prohibiting the brake fluid discharged from the cylinder section 31 from flowing into the tank section 50. Further, when the solenoid coil is in an energized state, the master bypass valve 61 is in an communicating state, thereby opening the first flow path 41 and allowing the brake fluid discharged from the cylinder section 31 to flow into the tank section 50.

The cut valve 62 is a two-position solenoid valve of normally open type that can control a communicating state and a blocking state. Specifically, when the solenoid coil is in a non-energized state, the cut valve 62 is in the communicating state, thereby opening the second flow path 42 and transferring the brake fluid discharged from the cylinder section 31 to the second actuator 70. Further, when the solenoid coil is in an energized state, the cut valve 62 is in the blocking state, thereby closing the second flow path 42 and prohibiting the brake fluid discharged from the cylinder section 31 from flowing the second actuator 70 through the second flow path 42.

The master bypass valve 61 and the cut valve 62 are configured to be controllable by a control signal transmitted from the first ECU 91, and receive power for driving from the power supply 90.

The tank section 50 is a tank that stores brake fluid. The tank section 50 is provided in the first flow path 41 and stores the brake fluid flowing in from the first flow path 41 when the brake fluid is discharged from the cylinder section 31 while the master bypass valve 61 is in the communicating state. Here, the tank section 50 has a space in which a sufficient amount of brake fluid can be stored, and the pressure in the internal space is approximately the same as atmospheric pressure.

Therefore, the brake fluid stored in the tank section 50 due to the brake fluid flowing into the tank section 50 from the first flow path 41 hardly generates a reaction force on the piston rod 32. That is, when the brake pedal 10 is operated by the driver, the master cylinder 30 does not generate a reaction force on the lever section 12 in accordance with the depression force of the brake pedal 10. The tank section 50 is connected to the first actuator 51 and is configured to be able to discharge the stored brake fluid to the first actuator 51.

The first actuator 51 is a pressurizing section that pressurizes the brake fluid supplied from the tank section 50 based on a control signal transmitted from the first ECU 91. In other words, the first actuator 51 is a pressurizing section that pressurizes the brake fluid stored in the tank section 50 to a brake fluid pressure corresponding to the amount of operation of the brake pedal 10.

The first actuator 51 increases the brake fluid pressure based on the control signal transmitted from the first ECU 91, thereby adjusting the brake fluid pressure to each of the W/C2 for the left front wheel, the W/C3 for the right front wheel, the W/C4 for the left rear wheel, and the W/C5 for the right rear wheel. Basically, in the brake device 1 including the first actuator 51, the force of the driver's depression of the brake pedal 10 is not directly transmitted to the W/C2 for the left front wheel, the W/C3 for the right front wheel, the W/C4 for the left rear wheel, and the W/C5 for the right rear wheel. That is, the brake device 1 of the present embodiment is a so-called brake-by-wire type brake.

The first actuator 51 includes a first pump 511 and a first pressure sensor 512. The first pump 511 is a pressurizing pump that increases the hydraulic pressure of brake fluid by being driven by a motor (not shown). The motor is driven by electric power supplied from the power supply 90, and its rotational speed is controlled based on a control signal from the first ECU 91. The first pump 511 increases the hydraulic pressure of the brake fluid supplied from the tank section 50 using the driving force supplied from the motor. The first pump 511 is connected to the second actuator 70 and supplies the pressurized brake fluid to the second actuator 70.

The first pressure sensor 512 is a pressure detection sensor that detects the hydraulic pressure of brake fluid pressurized by the first pump 511. The first pressure sensor 512 is connected to the first ECU 91 and outputs a detection signal corresponding to the detected hydraulic pressure to the first ECU 91.

The second actuator 70 has a flow path inside thereof that communicate with each of the W/C2 for the left front wheel, the W/C3 for the right front wheel, the W/C4 for the left rear wheel, and the W/C5 for the right rear wheel, and guides the brake fluid that has flowed into the second actuator 70 from the first flow path 41 and the second flow path 42 to each of the W/C2, the W/C3, the W/C4, and the W/C5. The second actuator 70 includes a control valve group 71, a second pump 72, and a second pressure sensor 73.

The control valve group 71 is a plurality of control valves for switching the flow paths inside the second actuator 70 based on a control signal from the second ECU 92 and adjusting the hydraulic pressure of the brake fluid flowing through the flow paths. Each control valve included in the control valve group 71 is provided in each flow path that guides the brake fluid flowing from the first actuator 51 into the W/C2 for the left front wheel, the W/C3 for the right front wheel, the W/C4 for the left rear wheel, and the W/C5 for the right rear wheel inside the second actuator 70. Each control valve included in the control valve group 71 is configured to be controllable by a control signal output from the second ECU 92.

The second pump 72 is a hydraulic pressure adjusting pump that is driven by a motor (not shown) to adjust the hydraulic pressure of the brake fluid supplied to each of the W/C2, the W/C3, the W/C4, and the W/C5, respectively. The motor is driven by electric power supplied from the power supply 90, and its rotational speed is controlled based on a control signal from the second ECU 92. The second pump 72 adjusts the hydraulic pressure of the brake fluid flowing out of the second actuator 70 by the driving force supplied from the motor.

The second pump 72 is connected to each of the W/C2, W/C3, W/C4, and W/C5 through respective flow paths leading to each of the W/C2, W/C3, W/C4, and W/C5, and supplies the brake fluid with adjusted hydraulic pressure to each of the W/C2, the W/C3, the W/C4, and the W/C5, respectively.

Further, the second pressure sensor 73 is a pressure detection sensor that detects the hydraulic pressure of the brake fluid flowing in the flow path inside the second actuator 70. The second pressure sensor 73 is connected to the second ECU 92 and outputs a detection signal corresponding to the detected hydraulic pressure to the second ECU 92.

When the motor that drives each control valve included in the control valve group 71 and the second pump 72 is not driven, the second actuator 70 transfers the brake fluid flowing in from the first actuator 51 to each of the W/C2, the W/C3, the W/C4, and the W/C5 respectively without adjusting the hydraulic pressure.

The power supply 90 is a power supply unit that supplies power to various components of the brake device 1, such as the first ECU 91, the second ECU 92, the master bypass valve 61, and the cut valve 62. The power supply 90 is connected to these various components.

The first ECU 91 includes a microcomputer including a CPU and a storage unit such as a ROM and a RAM, and peripheral circuits of the microcomputer. The first ECU 91 is connected to the stroke sensor 20 and the first pressure sensor 512 on its input side, and to the motor that drives the master bypass valve 61, the cut valve 62, and the first pump 511 on its output side. The first ECU 91 controls the rotation speed of the motor that drives the first pump 511 based on detection signals transmitted from the stroke sensor 20 and the first pressure sensor 512. Further, the first ECU 91 controls the operation of the master bypass valve 61 and the cut valve 62 based on the detection signal transmitted from the stroke sensor 20. A storage unit such as a ROM and a RAM of the first ECU 91 is constituted by a non-transitional physical storage medium.

Specifically, when the first ECU 91 detects the driver's depression operation of the pedal section 11 using the stroke sensor 20, the first ECU 91 supplies power to a solenoid coil of the master bypass valve 61, and brings the master bypass valve 61 into the communicating state. Furthermore, when the first ECU 91 detects the driver's depression operation of the pedal section 11 using the stroke sensor 20, it supplies power to the solenoid coil of the cut valve 62, thereby turning the cut valve 62 into the blocking state.

In other words, the first ECU 91 prohibits the brake fluid discharged from the cylinder section 31 from flowing into the second flow path 42 when the driver depresses the pedal section 11, and causes brake fluid discharged from the cylinder section 31 to flow through the first flow path 41.

On the other hand, when the brake device 1 malfunctions, the flow path through which the brake fluid discharged from the cylinder section 31 flows is switched from the first flow path 41 to the second flow path 42. Specifically, when the master bypass valve 61 and the cut valve 62 are not driven due to a malfunction of the first ECU 91, the power supply 90, etc., the flow paths from the cylinder section 31 to each of the W/C2, the W/C3, the W/C4, and the W/C5 are switched.

The reason why the flow path is switched in this way will be explained. When the power cannot be supplied from the power supply 90 to the master bypass valve 61 due to a malfunction of the power supply 90, the master bypass valve 61 is in the blocking state because the supply of power to the solenoid coil is stopped. Furthermore, when the power cannot be supplied from the power supply 90 to the cut valve 62 due to a malfunction of the power supply 90, the cut valve 62 is in the communicating state because the supply of power to the solenoid coil is stopped.

Further, when the control signal cannot be transmitted from the first ECU 91 to the master bypass valve 61 due to a malfunction of the first ECU 91, the master bypass valve 61 is in the blocking state, as in the case of the malfunction of the power supply 90. When a control signal cannot be transmitted from the first ECU 91 to the cut valve 62 due to a malfunction of the first ECU 91, the cut valve 62 in the communicating state, similar to the malfunction of the power supply 90.

That is, when the brake device 1 fails and cannot control the driving of the master bypass valve 61 and the cut valve 62, the brake fluid discharged from the cylinder section 31 is prohibited from flowing into the first flow path 41, and flows to the second actuator 70 via the second flow path 42. In this way, depending on whether the brake device 1 is not malfunctioning or malfunctioning, the flow path through which the brake fluid discharged from the cylinder section 31 flows is configured to be switched by the master bypass valve 61, the cut valve 62, and the first ECU 91. In the present embodiment, the master bypass valve 61, the cut valve 62, and the first ECU 91 function as a flow path switching section.

The first ECU 91 may be configured to be able to detect a malfunction of the first actuator 51. The malfunction of the first actuator 51 detected by the first ECU 91 is assumed to be, for example, a malfunction of the first pump 511, the first pressure sensor 512, the motor that drives the first pump 511, or the like.

The first ECU 91 may be configured to, when detecting a malfunction of the first actuator 51, put the master bypass valve 61 in the blocking state and put the cut valve 62 in the communicating state. In this case, the first ECU 91 may be configured to, when a malfunction of the first actuator 51 is not detected, put the master bypass valve 61 into the communicating state and put the cut valve 62 into the blocking state.

The second ECU 92 includes a microcomputer including a CPU and a storage unit such as a ROM and a RAM, and peripheral circuits of the microcomputer. The second ECU 92 is connected to the second pressure sensor 73 on its input side, and to each of the control valves included in the control valve group 71 of the second actuator 70 and the motor that drives the second pump 72 on its output side. The second ECU 92 controls the operation of each control valve included in the control valve group 71 and the rotation speed of the motor that drives the second pump 72 based on the detection signal transmitted from the second pressure sensor 73. A storage unit such as a ROM and a RAM of the second ECU 92 is constituted by a non-transitional physical storage medium.

Next, the reaction force generating section 80 will be explained with reference to FIG. 2. The reaction force generating section 80 is a device that generates a reaction force on the brake pedal 10 according to the depression force applied to the brake pedal 10 by the driver, thereby providing the driver with a feeling of operating the brake pedal 10. The reaction force generating section 80 has a housing 81 and an elastic member 82.

The housing 81 houses the elastic member 82, the cylinder section 31, and the piston rod 32. The housing 81 is provided inside the vehicle interior. Specifically, the housing 81 is attached to a dash panel D, which is a partition wall that separates the outside of the vehicle, such as the engine room, from the interior of the vehicle, inside a dashboard (not shown) provided inside the vehicle interior. In some cases, the dash panel D is referred to as a bulkhead. Hereinafter, for the sake of explanation and convenience, an upward direction relative to the front of the vehicle will simply be referred to as “upward”, and a downward direction relative to the front of the vehicle will simply be described as “downward”.

The housing 81 has a hollow square tube shape with a bottom, and of the outer wall parts surrounding the hollow part, the outer wall part on the side attached to the dash panel D protrudes upward and downward. In the housing 81, the protruding portion of the housing 81 is attached to the dash panel D such that the upward side of the housing 81 is a bottom side and the downward side is an opening side. The housing 81 has a first mounting portion 811, a second mounting portion 812, a housing bottom portion 813, and a housing cylindrical portion 814.

Although the master reservoir 33 is omitted in FIG. 2, the master reservoir 33 may be attached to an outer circumference of the housing 81. Furthermore, the master reservoir 33 may be housed within the housing 81.

The first mounting portion 811 and the second mounting portion 812 are members for attaching the housing 81 to the dash panel D, and are portions of the outer wall that extend upward and downward. The first mounting portion 811 is connected to a housing bottom portion 813, which will be described later, and extends upward from the housing bottom portion 813. Furthermore, a first mounting hole 815 is formed in the first mounting portion 811. The first mounting portion 811 is attached to the dash panel D by inserting a bolt B into the first mounting hole 815 and a first hole D1 of the dash panel D. Herein, the bolt B is inserted so as not to penetrate through the dash panel D.

The second mounting portion 812 is connected to a housing cylindrical portion 814, which will be described later, and extends downward from the housing cylindrical portion 814. Further, a second mounting hole 816 is formed in the second mounting portion 812. The second mounting portion 812 is attached to the dash panel D by inserting a bolt B into the second mounting hole 816 and a second hole D2 of the dash panel D.

The housing bottom portion 813 is a portion on the bottom side of the bottomed cylindrical housing 81. The housing bottom portion 813 supports a part of the lever section 12 such that the lever section 12 is rotatable about the rotating shaft 13. The housing bottom portion 813 also supports the stroke sensor 20.

The housing cylindrical portion 814 is a portion that forms a reaction force accommodating portion 817 that accommodates the elastic member 82. The housing cylindrical portion 814 has a square cylinder shape, is connected to the housing bottom portion 813, and extends downward from the housing bottom portion 813. Further, the housing cylindrical portion 814 accommodates the elastic member 82 and accommodates a portion of the lever section 12 that is connected to the elastic member 82 in the reaction force accommodating portion 817.

A flow path hole 818 for guiding the brake fluid flow path 40 to the reaction force accommodating portion 817 is formed in the housing cylindrical portion 814. The brake fluid flow path 40 is inserted through a through hole D3 formed in the dash panel D and the flow path hole 818, and is connected to the cylinder section 31 of the master cylinder 30.

The bottom portion of the cylinder section 31 is attached to an inner wall surface of the housing cylindrical portion 814. Further, the piston rod 32 inserted into the opening side of the cylinder section 31 is connected to a front surface 12a of the lever section 12.

By generating a reaction force on the lever section 12, the elastic member 82 is a member that generates a reaction force in accordance with the depression force of the brake pedal 10 by the driver. Specifically, the elastic member 82 is connected to the inner wall surface of the housing cylindrical portion 814 and the lever section 12, and generates the reaction force on the lever section 12 according to the rotation angle of the lever section 12 rotated by the driver's depression operation of the pedal section 11 of the driver. The elastic member 82 of the present embodiment is made of a member having a predetermined elastic modulus.

The elastic member 82 is, for example, equally spaced pitch springs, and is arranged so as to be elastically deformable along a longitudinal direction of the vehicle. The elastic member 82 has its front side connected to a surface on the front side of the inner wall surface of the housing cylindrical portion 814, and its rear side connected to the front surface 12a of the lever section 12. The elastic member 82 is disposed in a state in which it does not expand or contract itself, that is, in a state in which it does not generate elastic force when the pedal section 11 is not depressed by the driver. In other words, the elastic member 82 is arranged so that its length becomes the natural length when the pedal section 11 is not depressed by the driver.

In this way, the elastic member 82 of the present embodiment is mechanically directly connected to the brake pedal 10 without the master cylinder 30 intervening. Further, the elastic member 82 is directly connected to the brake pedal 10 without flowing through the brake fluid flow path 40 through which the brake fluid flows, so that the brake fluid does not flow between the brake pedal 10 and the elastic member 82.

When the pedal section 11 is depressed by the driver's depression force, a force corresponding to the pedal force is transmitted from the lever section 12 to the elastic member 82. As a result, the elastic member 82 is elastically deformed, and a restoring force is generated in the elastic member 82. Specifically, the elastic member 82 composed of equally spaced pitch springs contracts when the pedal section 11 is depressed by the driver's depression force, and generates a restoring force to return from the contracted state to the state before contraction. This restoring force generates the reaction force against the lever section 12.

The restoring force of the elastic member 82 is proportional to a deformation amount of the elastic member 82. Furthermore, the amount of deformation of the elastic member 82 increases as the rotation angle of the lever section 12 increases. Therefore, the restoring force of the elastic member 82 increases as the rotation angle of the lever section 12 increases. In the present embodiment, the elastic member 82 is set so that the rotation angle of the lever section 12 and the reaction force have a linear relationship.

Next, the operation of the brake device 1 will be explained. First, the operation will be described when the brake device 1 is in a normal state with no malfunction and power can be supplied from the power supply 90 to the master bypass valve 61 and the cut valve 62.

In the case where the brake device 1 is not malfunctioning, the first ECU 91 does not transmit a control signal to the master bypass valve 61 and the cut valve 62 in an initial state in which the brake pedal 10 is not depressed by the driver. That is, the first ECU 91 puts the master bypass valve 61 in the blocking state and puts the cut valve 62 in the communicating state. Thereby, the storage chamber 311 of the cylinder section 31 communicates with the second actuator 70 via the second flow path 42.

Further, in an initial state where the driver does not press the brake pedal 10, the lever section 12 is not rotating. When the driver depresses the brake pedal 10, the lever section 12 rotates around the rotating shaft 13. As a result, the rotation angle of the lever section 12 changes.

When the lever section 12 rotates around the rotating shaft 13, the stroke sensor 20 detects the rotation angle of the lever section 12, and outputs a detection signal according to the rotation angle to the first ECU 91. Then, when the first ECU 91 detects that the lever section 12 has rotated, it sends a control signal to the master bypass valve 61 and the cut valve 62 to put the master bypass valve 61 in the communicating state and put the cut valve 62 in the blocking state. As a result, the storage chamber 311 of the cylinder section 31 is communicated with the first actuator 51 via the first flow path 41, and the storage chamber 311 of the cylinder section 31 is disconnected from the second actuator 70.

Moreover, when the lever section 12 rotates around the rotating shaft 13, the piston rod 32 connected to the lever section 12 is pushed into the cylinder section 31. Thereby, the brake fluid stored in the cylinder section 31 is discharged into the brake fluid flow path 40. When the brake fluid is discharged from the cylinder section 31 into the brake fluid flow path 40, the tank section 50 stores the brake fluid flowing in from the first flow path 41. At this time, the brake fluid in the tank section 50 is hardly pressurized. Furthermore, no brake fluid pressure is generated in the brake fluid within the brake fluid flow path 40.

Furthermore, the first ECU 91 calculates a target brake fluid pressure based on the detection signal of the stroke sensor 20. The first ECU 91 then controls the rotation speed of the motor that drives the first pump 511 so that the hydraulic pressure of the brake fluid flowing from the tank section 50 to the first actuator 51 approaches the target brake fluid pressure. The first pressure sensor 512 detects the hydraulic pressure of the brake fluid pressurized by the first pump 511, and outputs a detection signal according to the detected hydraulic pressure to the first ECU 91. The first ECU 91 adjusts the brake fluid pressure so as to approach the target brake fluid pressure by performing feedback control. The first actuator 51 then causes the brake fluid whose hydraulic pressure has been adjusted to flow into the second actuator 70.

Further, when the brake pedal 10 is depressed by the driver, the second ECU 92 determines whether conditions for executing the control of ABS (Anti-lock Brake System) and ESC (Electric Stability Control) are satisfied.

When the ABS control execution conditions and the ESC control execution conditions are not satisfied, the second ECU 92 causes the brake fluid pressurized by the first actuator 51 to approach the target brake fluid pressure to flow into each of the W/C2, the W/C3, the W/C4, and the W/C5 without adjusting the fluid pressure. As a result, the brake fluid that has flowed from the first actuator 51 to the second actuator 70 flows to each of the W/C2, the W/C3, the W/C4, and the W/C5. Therefore, each brake pad (not shown) provided on each of the wheels FL, FR, RL, and RR comes into frictional contact with its corresponding brake disc, and the vehicle is decelerated.

The determination as to whether or not to execute ABS control is made by calculating the respective slip ratios of the left front wheel FL, the right front wheel FR, the left rear wheel RL, and the right rear wheel RR based on each of the wheel speeds and vehicle speed of the vehicle. Then, when an execution condition for the ABS control is satisfied, the second ECU 92 controls each control valve included in the control valve group 71 of the second actuator 70 based on this slip ratio, and adjusts the hydraulic pressure of the brake fluid flowing in the W/C2, the W/C3, the W/C4, and the W/C5. As a result, the slip ratio of each wheel of the vehicle is controlled, so that the front left wheel FL, the front right wheel FR, the rear left wheel RL, and the rear right wheel RR are prevented from locking.

The determination as to whether or not to execute ESC control is made by calculating the skid state of the vehicle based on, for example, the yaw rate, steering angle, acceleration, speed of each wheel, vehicle speed, and the like. Then, when an execution condition for the ESC control is satisfied, the second ECU 92 selects a wheel to be controlled for stabilizing the turning of the vehicle based on a skidding state of the vehicle.

Further, the second ECU 92 controls each control valve included in the control valve group 71 in order to pressurize the W/C corresponding to the selected target wheel to be controlled, and in addition to the above, the second ECU 92 drives a motor that drives the second pump 72, thereby driving the second pump 72 corresponding to the wheel to be controlled. The brake fluid pressurized by the second pump 72 flows to the W/C corresponding to the wheel to be controlled. As a result, the W/C corresponding to the wheel to be controlled is pressurized, and skidding of the vehicle is suppressed. Therefore, the traveling of the vehicle becomes stable.

In this way, the second ECU 92 performs the ABS control, the ESC control, etc. At this time, in addition to the ABS control and the ESC control described above, the second ECU 92 may perform a collision avoidance control, a regeneration coordination control, etc. based on control signal from other ECUs (not shown).

Further, when the lever section 12 rotates around the rotating shaft 13, the elastic member 82 is pressed by the lever section 12 and contracts. Thereby, the elastic member 82 generates the reaction force in the lever section 12 due to the restoring force. That is, the elastic member 82 generates the reaction force on the brake pedal 10 in accordance with the depression force applied to the pedal section 11 by the driver. The elastic member 82 generates a larger reaction force on the brake pedal 10 as the amount of deformation of the elastic member 82 becomes larger.

As described above, the brake fluid discharged from the cylinder section 31 when the driver depresses the brake pedal 10 only moves into the tank section 50 without generating brake fluid pressure. Therefore, almost no reaction force based on the brake fluid pressure is generated on the brake pedal 10.

When the driver's foot comes off the pedal section 11, the reaction force generating section 80 returns the brake pedal 10 to the initial state by the restoring force of the elastic member 82.

As described above, when the brake device 1 is not malfunctioning and the driver depresses the brake pedal 10, the brake fluid stored in the storage chamber 311 is discharged into the brake fluid path 40 by pushing the piston rod 32 into the cylinder section 31. Moreover, the brake fluid discharged into the brake fluid flow path 40 is guided to the tank section 50 by putting the master bypass valve 61 in the communicating state and putting the cut valve 62 in the blocking state.

Next, a case where the brake device 1 is in a malfunctioning state will be described. Here, a case in which the brake device 1 is in the malfunctioning state, for example, a case in which the power supply 90 is malfunctioning and power cannot be supplied from the power supply 90 to the master bypass valve 61 and the cut valve 62, will be described.

When the brake device 1 is in a malfunctioning state such that the power supply 90 is malfunctioning, the master bypass valve 61 and the cut valve 62 cannot receive power from the power supply 90. In this case, in the initial state where the driver does not depress the brake pedal 10, as in the case where the brake device 1 is not malfunctioning, the storage chamber 311 of the cylinder section 31 is in communication with the second actuator 70 via the second flow path 42.

When the driver depresses the brake pedal 10, the piston rod 32 connected to the lever section 12 is pushed into the cylinder section 31. Thereby, the brake fluid stored in the cylinder section 31 is discharged into the brake fluid flow path 40.

However, since electric power cannot be received from the power supply 90, the master bypass valve 61 and the cut valve 62 cannot be driven even if they receive a control signal from the first ECU 91. Therefore, a state in which the storage chamber 311 of the cylindrical portion 31 is maintained in communication with the second actuator 70 via the second flow path 42 is maintained. Then, when the brake fluid is discharged from the cylinder section 31 into the brake fluid flow path 40, the brake fluid flows into the second actuator 70 from the second flow path 42, and further flows into each of the W/C2, the W/C3, the W/C4, and the W/C5.

In addition, when flowing the brake fluid into each of the W/C2, the W/C3, the W/C4, and the W/C5, the brake fluid is pressurized by the driver's depression force on the pedal portion 11. Therefore, each brake pad (not shown) provided on each of the wheels FL, FR, RL, and RR comes into frictional contact with its corresponding brake disc, and the vehicle is decelerated. In this way, even in a malfunctioning state in which the power supply 90 of the brake device 1 is malfunctioning, the brake device 1 can brake the vehicle in the same way as in a normal state.

Moreover, when the lever section 12 rotates around the rotating shaft 13, the elastic member 82 is pressed by the lever section 12 and contracts, as in the case where the brake device 1 is not malfunctioning. Thereby, the elastic member 82 generates the reaction force in the lever section 12 due to the restoring force. That is, the elastic member 82 generates the reaction force on the brake pedal 10 in accordance with the depression force applied to the pedal section 11 by the driver.

By the way, when the brake device 1 is in a malfunctioning state, the storage chamber 311 communicates with each of the W/C2, the W/C3, the W/C4, and the W/C5 via the second flow path 42 and the second actuator 70. The brake fluid present in the storage chamber 311, the second flow path 42, the second actuator 70, and each of the W/C2, the W/C3, the W/C4, and the W/C5 is pressurized to brake fluid pressure by the driver's depression force on the pedal section 11. Therefore, the brake fluid generates a reaction force on the piston rod 32 according to the driver's depression force.

Therefore, when the brake device 1 is in a malfunctioning state, the brake pedal 10 is not only given the reaction force by the elastic member 82 but also given the reaction force from the brake fluid pressurized to the brake fluid pressure. That is, when the brake device 1 is in a malfunctioning state, a larger reaction force is applied to the brake pedal 10 than when the brake device 1 is normal.

When the driver's foot comes off the pedal portion 11, the brake pedal 10 returns to its initial state due to the reaction force generated by the elastic member 82 and the reaction force generated by the brake fluid.

In this way, in a state where the brake device 1 is malfunctioning, when the driver depresses the brake pedal 10, the brake fluid stored in the storage chamber 311 is discharged into the brake fluid flow path 40 as in the case where the brake device 1 is not malfunctioning. Further, by putting the master bypass valve 61 in the blocking state and the cut valve 62 in the communicating state, the brake fluid discharged into the brake fluid flow path 40 is guided to each of the W/C2, the W/C3, the W/C4, and the W/C5 without flowing through the tank section 50 and the first actuator 51.

In addition, although the case where the power supply 90 is malfunctioning has been described here as an example of the case where the brake device 1 is in the malfunctioning state, the malfunctions in other component devices other than the power supply 90 are also conceivable. For example, another example of the case where the brake device 1 is in a malfunctioning state is a case where the first ECU 91 is malfunctioning. In this case, even if the power supply 90 is not malfunctioning, the control signal cannot be sent from the first ECU 91 to the master bypass valve 61 and the cut valve 62, so the operation will be the same as in the case where the power supply 90 is malfunctioning.

Another example of a case where the brake device 1 is malfunctioning is a case where the first actuator 51 is malfunctioning. When the first ECU 91 detects a malfunction in the first actuator 51, the first ECU 91 may control various component devices to operate in the same manner as when the power supply 90 is malfunctioning.

Furthermore, another example of the case where the brake device 1 is in a malfunctioning state is a case where the master bypass valve 61 and the cut valve 62 are malfunctioning. When the first ECU 91 detects a malfunction of the master bypass valve 61 and the cut valve 62, the first ECU 91 may control various component devices to operate in the same manner as when the power supply 90 is malfunctioning.

As described above, in the brake device 1 of the present embodiment, the elastic member 82 is mechanically directly connected to the brake pedal 10 without using the master cylinder 30. Then, when the driver depresses the pedal section 11, the brake fluid does not flow between the brake pedal 10 and the elastic member 82.

If a component device that generates a reaction force to the brake pedal 10 is configured to have a flow path through which brake fluid flows, such as a stroke simulator, a sealing member is provided at a portion connecting the flow path and the stroke simulator. When the pressurized brake fluid flows into the flow path due to the driver's depression operation of the pedal section 11, there is a possibility that the pressurized brake fluid may deform the sealing member and cause air to enter the flow path.

The mixture of air in the flow path changes the reaction force generated by the stroke simulator, and becomes a factor that prevents the driver from obtaining an appropriate feeling of depressing the brake pedal 10. Furthermore, if air gets mixed into the flow path, there is a possibility that the stroke simulator will no longer generate the reaction force.

On the other hand, in the brake device 1 of the present embodiment, the elastic member 82 is mechanically directly connected to the brake pedal 10 without using the master cylinder 30. Therefore, no brake fluid is present between the brake pedal 10 and the elastic member 82. Therefore, the reaction force generated by the elastic member 82 can be directly transmitted to the brake pedal 10, so that the operational feeling of the brake pedal 10 can be improved.

In addition, when the brake device 1 of the present embodiment operates in a normal state, the brake device 1 is a brake-by-wire type brake in which the force of the driver's depression of the brake pedal 10 is not directly transmitted to the W/C2 for the left front wheel, the W/C3 for right front wheel, the W/C4 for left rear wheel, and the W/C5 for right rear wheel, respectively.

Therefore, when the brake device 1 is in a normal state, the brake fluid discharged from the master cylinder 30 moves into the tank section 50 without being pressurized by the brake fluid pressure.

Therefore, regardless of whether the brake device 1 is in a normal state or an abnormal state, the load applied to the seal member provided in the brake fluid flow path 40 is reduced, compared to the case where the brake fluid pressurized to the brake fluid pressure flows into the brake fluid flow path 40. Therefore, it is possible to prevent air from entering the brake fluid flow path 40 due to deformation of the seal member.

According to the embodiment described above, it is possible to achieve the following advantageous effects.
(1) In the embodiment described above, the brake pedal 10, the reaction force generating section 80, and the master cylinder 30 are provided inside the vehicle interior.

If the reaction force generation section 80 and the master cylinder 30 are provided outside the vehicle interior, for example, in the engine room, the reaction force generation section 80 and the master cylinder 30 are connected to the brake pedal 10 across the dash panel D. In this case, when designing the brake device 1, it is necessary to consider both the installation space inside the engine room outside the vehicle interior and the installation space inside the dash panel inside the vehicle interior.

On the other hand, the brake device 1 of the present embodiment has a configuration in which the brake pedal 10, the reaction force generating section 80, and the master cylinder 30 are provided inside the vehicle interior, and has a configuration in which the reaction force generating section 80 and the master cylinder 30 are connected to the brake pedal 10 without across the dash panel D. Therefore, when designing the brake device 1, it is only necessary to consider the installation space inside the vehicle interior, and the degree of freedom in the mounting position of the brake device 1 can be improved.
(2) In the above embodiment, the brake device 1 includes each of the W/C2, the W/C3, the W/C4, and the W/C5 that apply braking force to the wheels of the vehicle by being activated by the hydraulic pressure of brake fluid and the master bypass valve 61, the cut valve 62, and the first ECU 91 that functions as a flow path switching section. When the brake device 1 is not malfunctioning, the brake device 1 guides the brake fluid flowing through the brake fluid flow path 40 to each of the W/C2, the W/C3, the W/C4, and the W/C5 via the tank section 50 and the first actuator 51. In addition, when the brake device 1 is malfunctioning, the brake device 1 guides the brake fluid flowing through the brake fluid flow path 40 to each of the W/C2, the W/C3, the W/C4, and the W/C5 without flowing through the tank section 50 and the first actuator 51.

According to this configuration, when the brake device 1 is not malfunctioning, the brake device 1 causes the pressurized brake fluid based on the rotation angle of the lever section 12 detected by the stroke sensor 20 to flow into each of the W/C2, the W/C3, the W/C4, and the W/C5 from the first actuator 51. Therefore, when the brake device 1 is not malfunctioning, each of the W/C2, the W/C3, the W/C4, and the W/C5 is activated by the hydraulic pressure of the brake fluid pressurized by the first actuator 51 to apply braking force to the wheels.

Further, when the brake device 1 is malfunctioning, the brake device 1 supplies the brake fluid discharged from the master cylinder 30 to each of the W/C2, the W/C3, the W/C4, and the W/C5 without flowing through the tank section 50 and the first actuator 51. Therefore, even if the brake device 1 is malfunctioning, each of the W/C2, the W/C3, the W/C4, and the W/C5 is pressurized and the vehicle can be braked.
(3) In the embodiment described above, the brake fluid flow path 40 has the first flow path 41 and the second flow path 42. The first flow path 41 guides the brake fluid discharged from the cylinder section 31 to each of the W/C2, the W/C3, the W/C4, and the W/C5 via the tank section 50 and the first actuator 51. The second flow path 42 guides the brake fluid discharged from the cylinder section 31 to each of the W/C2, the W/C3, the W/C4, and the W/C5 without flowing through the tank section 50 and the first actuator 51. The brake device 1 also includes the master bypass valve 61 of normally closed type disposed in the first flow path 41 and the cut valve 62 of normally open type disposed in the second flow path 42.

Then, when the brake device 1 is not malfunctioning, the brake device 1 puts the master bypass valve 61 in the communicating state and puts the cut valve 62 in the blocking state. The brake device 1 then guides the brake fluid discharged from the cylinder section 31 to each of the W/C2, the W/C3, the W/C4, and the W/C5 via the tank section 50 and the first actuator 51. Further, when the brake device 1 is malfunctioning, the master bypass valve 61 is in the blocking state. Then, when the brake device 1 is malfunctioning, the cut valve 62 is in the communicating state. The brake device 1 guides the brake fluid discharged from the cylinder section 31 to each of the W/C2, the W/C3, the W/C4, and the W/C5 without flowing through the tank section 50 and the first actuator 51.

According to this configuration, the brake device 1 can supply the brake fluid discharged from the master cylinder 30 to each of the W/C2, the W/C3, the W/C4, and the W/C5 without performing a special control when the brake device 1 is malfunctioning. Therefore, even if the brake device 1 is malfunctioning, the vehicle can be reliably braked.

### OTHER EMBODIMENTS

Although representative embodiments of the present disclosure have been described above, the present disclosure is not limited to the embodiments described above, and various modifications can be made, for example, as follows.

In the above-described embodiment, an example in which the elastic member 82 is composed of equally spaced pitch springs has been described, but the present disclosure is not limited to this configuration. For example, the elastic member 82 may be formed of a spring having a shape different from that of a regular pitch spring, such as an uneven pitch spring or a conical coil spring. Further, the elastic member 82 may be made of an elastic material different from a spring, such as a rubber member.

In the above-described embodiment, a configuration in which the reaction force generating section 80 includes one elastic member 82 has been described, but the present disclosure is not limited to this configuration. For example, the reaction force generating section 80 may include a plurality of elastic members 82, and the plurality of elastic members 82 may be connected in series or in parallel.

In the above-described embodiment, a configuration in which the brake pedal 10, the reaction force generating section 80, and the master cylinder 30 are provided inside the vehicle interior has been described, but the present disclosure is not limited to this configuration. For example, at least one of the reaction force generating section 80 and the master reservoir 33 may be provided outside the vehicle interior.

In the embodiment described above, a configuration in which the flow path through which the brake fluid flows is switched between the first flow path 41 and the second flow path 42 depending on whether the brake device 1 is not malfunctioning or when the brake device 1 is malfunctioning has been described, but the present disclosure is not limited to this configuration. For example, the brake device 1 may have a configuration in which the flow path through which the brake fluid flows does not switch between the first flow path 41 and the second flow path 42. Specifically, the brake device 1 may have a configuration that does not include the second flow path 42 through which the brake fluid flows when the brake device 1 is malfunctioning.

In the above embodiment, a configuration in which the brake device 1 includes the first ECU 91 and the second ECU 92, and each of the first ECU 91 and the second ECU 92 controls different devices has been described, but the present disclosure is not limited to this configuration. For example, the brake device 1 may have one ECU, and the ECU may control various components of the brake device 1.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, it is not limited to the shape, positional relationship, and the like, except for the case where it is specifically specified, the case where it is fundamentally limited to a specific shape, positional relationship, and the like, and the like.

What is claimed is:

1. A brake device for braking wheels of a vehicle, comprising:
a brake pedal;
a pedal operation detection section configured to detect an amount of operation of the brake pedal;
a tank section configured to store brake fluid;
an actuator configured to pressurize the brake fluid stored in the tank section to a brake fluid pressure corresponding to the amount of operation of the brake pedal;
a master cylinder including a cylinder section configured to form a storage chamber for storing brake fluid and a piston rod that connects to the brake pedal and pushes out the brake fluid stored in the storage chamber and discharges the brake fluid to an outside of the cylinder section by moving a distance corresponding to the amount of operation of the brake pedal;
a brake fluid flow path configures to guide the brake fluid discharged from the storage chamber by being pushed out by the piston rod to the tank section; and
a reaction force generating section being connected to the brake pedal and including an elastic member configured to generate a reaction force on the brake pedal by elastically deforming according to the amount of operation of the brake pedal.

2. The brake device according to claim 1, further comprising,
wheel cylinders configured to apply braking force to wheels of the vehicle by being activated by hydraulic pressure of the brake fluid, and
a flow path switching section
configured to guide the brake fluid flowing through the brake fluid flow path to the wheel cylinder through the tank section and the actuator when the brake device is not malfunctioning, and
configured to guide the brake fluid flowing through the brake fluid flow path to the wheel cylinder without flowing through the tank section and the actuator when the brake device is malfunctioning.

3. The brake device according to claim 2, wherein
the brake fluid flow path includes a first flow path configured to guide the brake fluid discharged from the cylinder section to the wheel cylinder through the tank section and the actuator, and a second flow path configured to guide the brake fluid discharged from the cylinder section to the wheel cylinder without flowing through the tank section and the actuator,
the flow path switching section includes a first control valve of normally closed type disposed in the first flow path, and a second control valve of normally open type disposed in the second flow path,
when brake device is not malfunctioning, the brake fluid discharged from the cylinder section is guided to the wheel cylinder through the tank section and the actuator by putting the first control valve in a communicating state and the second control valve in a blocking state, and
when brake device is malfunctioning, the brake fluid discharged from the cylinder section is guided to the wheel cylinder without flowing through the tank section and the actuator by putting the first control valve in the blocking state and the second control valve in the communicating state.

4. The brake device according to claim 1, wherein
the brake pedal, the master cylinder, and the reaction force generating section are provided inside a vehicle interior.
